(19) United States
(12) Patent Application Publication
(10) Pub. No.: US 2003/0061086 A1
(43) Pub. Date: Mar. 27, 2003

(54) System and means for supporting transportations and distributions

(75) Inventors: Hui-Chuan Chen, Hsinchu (TW); Chih-Teng Chen, Hsin Tien City (TW); Pi-Chuan Hung, TaiChung (TW); Chang-Lin Yang, HsinWu Hsiang (TW); Chung-En Kao, Taipei (TW); Jiin-Liuh Huang, TaoYuan (TW); Tsai-Sui Weng, Taipei (TW)

Correspondence Address: DOUGHERTY & TROXELL, SUITE 1404, 5205 LEESBURG PIKE, FALLS CHURCH, VA, 22041, US

(73) Assignee: Industrial Technology Research Institute

(21) Appl. No.: 09/996,809

(22) Filed: Nov. 30, 2001

(30) Foreign Application Priority Data
Sep. 26, 2001 (TW) 90123688

(51) Int. Cl. G06F 17/60

(52) U.S. Cl. 705/8

(57) ABSTRACT

The present invention is a system and means for supporting transportations and distributions, which is the logistic system and means applied on the management of supporting T&D of delivering goods from a place to at least one other place. For system, which has plural systems for distribution plans of goods before distributions, monitoring, control and recording operations of goods in distributions and result evaluation operations of goods after distributions; the plural systems include a supporting T&D system, a distribution and returning process system and a transportation result management system. For means, which has plural modules as following: a basic data module, a distribution cost module, an geographic information system application module, a vehicle-arrangement and path plan module, a vehicle and driver assignment module, a monitoring and recording module, and a result management module. The modules may cooperate with general business enterprises.

### BACKGROUND OF THE INVENTION

1. Field of the Invention

The present invention relates to a system and means for supporting transportations and distributions (following called T&D to replace both “transportations and distributions” and “transportation and distribution”), especially a logistic system and means applied on that distributing goods from a place to at least one other place.

2. Description of the Related Art

For manufacturers, manufacturers produce products and sell or deliver them to distributors or agents; therefore the roles of moving and transporting are involved. For wholesalers, who plays the middle role, thus the goods they represent is from suppliers or manufacturers, and sold to customers or consumers, the both directions may consider the output and input of goods, hence, T&D are the needs. For customers or consumers, they are purely accepted delivered goods in appearance, but customer-trend is the major object at the present marketing, customers are the key roles for T&D and cannot be avoid them. For distribution centers of handling goods-flow business, T&D are the major missions and beneficial sources. Thus, the best time to deliver goods, the sort of vehicle for delivery, the most efficient way, the sequence for delivery, etc. are considered by manufacturers, wholesalers, distribution centers and retailers; on the other hand, the managing features are also affected. Especially, an integration including the needs, considerations, supply and business flow of manufacturers, wholesalers, distribution centers and retailers may produce an efficiency system for transportations and relative deliveries.

For traditional logistic, the most concerns for general businesses are efficiency, convenience, economy, communication and reliability. However, those businesses face a lot of difficulties and groan, which are listed as follows:

Spending much time from goods ordered to goods delivered

Not smoothly choosing transportation paths

Hardly decided for T&D plans

Complained by drivers for disproportional working time

Low efficiency for T&D

Not on time for T&D

Not clear evaluation criterion for T&D

Wherein, the point of spending much time from goods ordered to goods delivered is because of that all operations are by human being, ex. data input, calculation, distribution, gathering statistics; the point of not smoothly choosing transportation paths is caused by that it is hardly know the road and driver conditions; the plan for T&D may consider many directions, thus a whole complete plan is tough to be ready, and a set plan cannot bring its efficiency into full play, also, labor cannot be averagely shared between. Therefore, the customer requirements and the operation schedule are hardly to reach. At last, there are not an object and a standard to check the operation results, thus to improve the aforesaid shortcomings is very limited.

About the above shortcomings, at the old fashion of man-made plan, the senior man is responsible to make plan, whose experiences are priceless. Hence, those experiences are whether handed down to next generation or not, and they are whether suitable to the fast changing times or not, both of the above issues are the present difficult problems.

Besides, another problem happened in Taiwan and Japan is listed as appendix 1, which is the comparison table for Taiwan and Japan logistics. In Japan, working hour is limited in 9 hours, and more triumphs may be created because of the time frame; in Taiwan, labor fee is constantly increased, and management level tends to use high efficiency system. On the other hand, Japan customers seriously request the schedule. Japan customers may complain a lot if schedule is delayed more than two hours; Taiwan customers gradually focus on the issues of services, how to short time period of ordering and delivering, how to decrease schedule delay, etc. For vehicles, Japanese companies usually sign contracts with vehicle rental companies, and Taiwanese companies always use their own vehicles. Although the ways for using vehicles are different, both need good plans to support goods T&D. Further, no matter Taiwan or Japan, to foster another skilled generation is another problem, thus to build up an intellectual system is the right and present work. Non-governmental enterprises stepping into the research for the intellectual system are getting more in Japan; Taiwanese non-governmental organizations have no common consensus so far, but the idea to build up the intellectual system is gradually formed. Therefore, the non-governmental organizations hope a computerize system to support the operations of T&D.

### SUMMARY OF THE INVENTION

The first object of the present invention is to short the time interval of goods order to goods delivery for decreasing delay time via automatic vehicle-arrangement.

The present invention is discussed with two issues, which are module and procedure. About module issue, there are plural modules for data managements or commend executions in different directions. The plural modules are as following:

Basic Data Module

Distribution Cost Module

Geographic Information System Application Module

Vehicle Arrangement And Path Plan Module

Vehicle And Driver Assignment Module

Monitoring And Recording Module

Result Management Module

About procedure issue, which may control and manage goods before distribution, goods in distribution and goods after distribution. For the control and management of the goods before distribution, which includes distribution and vehicle allotment by order, automatic path arrangement, and the best plan for vehicle arrangement depends on full directions, thus the following difficulties are solved, which are:

Spending much time from goods ordered to goods delivered

Hardly decided for T&D plans

Complained by drivers for disproportional working time

Thus, the applications of the basic data module, the distribution module, the geographic information system application module and the vehicle arrangement and path plan module may totally figure out the difficulties of the control and management of the goods before distribution. For the control and management of the goods in distribution, the following difficulties may be solved, which are:

Not smoothly choosing transportation paths

Low efficiency for T&D

Not on time for T&D

By using the monitoring and recording module may monitor and record vehicle and road conditions when goods in distribution, this action help understanding every state during vehicles on their ways to their destinations. Thus, a similar or same condition happened could be fast figured out based on the previous record.

The second object of the present invention is to build up a set of evaluation standard for checking each of T&D, thus it helps relative businesses to understand that the support for T&D works according to the target of beneficial cost or not.

The result management module may have a result evaluation of all recording of vehicle before distribution and vehicle in distribution. Thus, the point of not clear evaluation criterion for T&D does no longer exist. The reason is that the result management module collects all related information based on plural times of dispatching vehicle to become statistics values, and then to evaluate the statistics, finally, an evaluation criterion may thus be produced.

For further understanding the present invention, please refer to the following drawings and preferred embodiments.

### BRIEF DESCRIPTION OF THE DRAWINGS

FIG. 1 is the scheme of the preferred embodiment of the module for the present invention.

FIG. 2 is the flow chart of the preferred embodiment of the supporting T&D system for the present invention.

FIG. 3 is the flow chart of the preferred embodiment of the distribution and returning process system for the present invention.

FIG. 4 is the flow chart of the preferred embodiment of the transportation result management system for the present invention.

Appendix 1 is the comparison table for Taiwan and Japan logistics.

### DESCRIPTION OF THE PREFERRED EMBODIMENTS

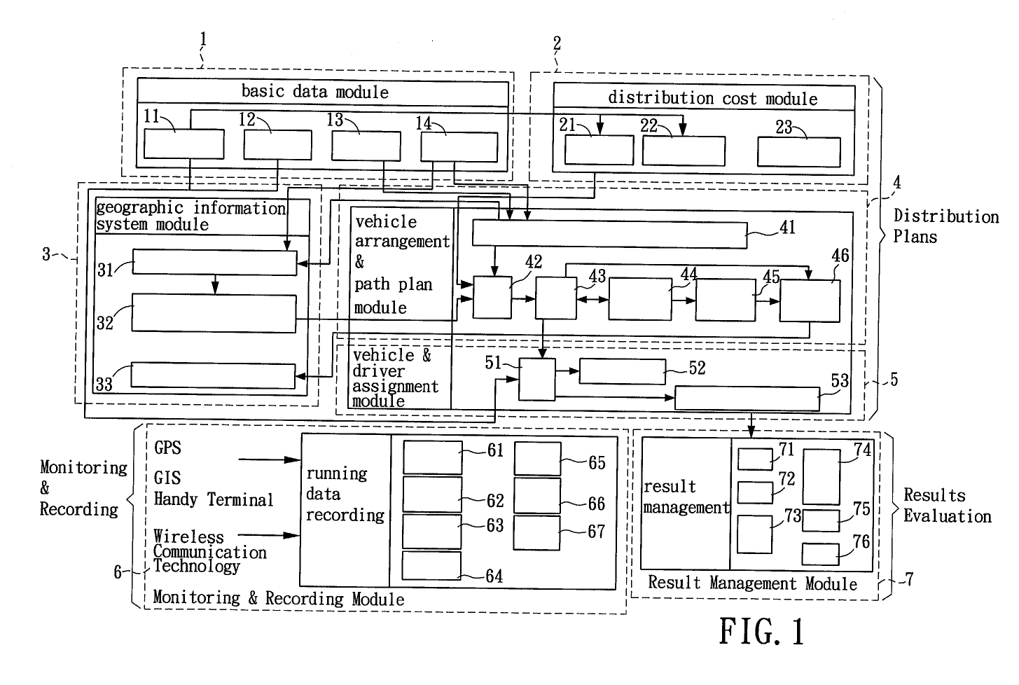

The present invention is a system and means for supporting T&D, especially a logistic procedure and module applied on that distributing goods from a place to at least one other place. For the module, please refer to FIG. 1, which is the scheme of the preferred embodiment of the module for the present invention. There are plural modules for the present invention, which are: basic data module 1, distribution cost module 2, geographic information system application module 3, vehicle arrangement and path plan module 4, vehicle and driver assignment module 5, monitoring and recording module 6 and result management module 7. Wherein, the basic data module 1 collects the information of the following modules and saves them in the basic data module 1 itself, the modules are: a T&D data maintain module 11 (including a database module of private vehicles and contract vehicles), a vehicle-arrangement principle module 12, a region data maintain module 13, a customer T&D data check and maintain module 14, etc. A contract vehicle expense module 21 and a private vehicle expense module 22 of the distribution cost module 2 function based on the vehicle data supplied from the T&D data maintain module 11, and a DC consign expense module 23 executes the function of cost maintaining as well. A customer location module 31 of the geographic information system application module 3 functions depending on the data supplied by the customer T&D data check and maintain module 14 and order data check and maintain module 41 (which data are from the region data maintain module 13 and the customer T&D data check and maintain module 14). Then, a logistic network calculation module 32 for the most economic values starts calculations for logistic network. The results of module 32, module 41 and module 2 are sent to an automatic/artificial/cut-in process module 42 and a vehicle-arrangement preview module 43 of the vehicle-arrangement and path plan module 4 to process, the processed results from module 43 are then sent to an geographic information system display module 46 to display; or to a trip adjustment/confirmation module 44, a trip assembly module 45 for more process, and then to module 46 for display. From module 43 to module 44, which is reversible for applying versatile path and vehicle arrangements, up to the stage, an order path network simulation is then brought out. After module 46 displaying results, an geographic information system display module 33 of the geographic information system application module 3 displays the same information as well. The information is a T&D path. After module 43 functioning, the results cooperate with the data provided by the T&D data maintain module 11 and the vehicle-arrangement principle module 12, and the results from the process of the aforesaid three modules are forwarded to a vehicle and driver assignment module 51 of the vehicle and driver assignment module 5 for functioning. That is the function of vehicle and driver assignment. Therefore, an assignment result check and print module 52 prints out final assignment result; on the other hand, an overall plan module 53 produces complete assignment information for vehicle and driver. The above description is the relationships among modules under the condition of goods before distribution.

The monitoring and recording module 6 functions the control and monitor of goods in distribution, which means to control each vehicle running conditions when goods in distribution, and to monitor and record vehicle paths and distribution time interval to the time of distribution finished. Please refer to FIG. 1, goods may be distributed when plan is done. Hence, a GIS in-and-out control module 61, a GPS/GIS vehicle monitor and control module 62, an acceptance recording module 63 and a distribution monitor and control module 64 cooperate with GPS (Global Positioning System), GIS (Geography Information System), HT (Handy Terminal) and wireless communication technology to record vehicle running conditions and paths. When relative data being transmitted to system center, which is applied by a path display module 65, a distribution maintain and trace module 66 and a distribution expense check and maintain module 67 to control and monitor for each trip within the time interval of goods distribution. The above description is the relationships among modules under the condition of goods in distribution.

After goods being sent to destinations, result evaluation is started, which focuses on that to evaluate and analysis the conditions of vehicles in distribution to have experience values. The result management module 7 is the role to handle the aforesaid evaluation and analysis process, which includes a time management module 71, a stowage management module 72, a driver and vehicle management module 73, a cost/expense/benefit/reward management module 74, a mileage management module 75 and a velocity management module 76. According to the aforesaid managements, a final result of evaluation is then come out, and the final result may be a reference for future.

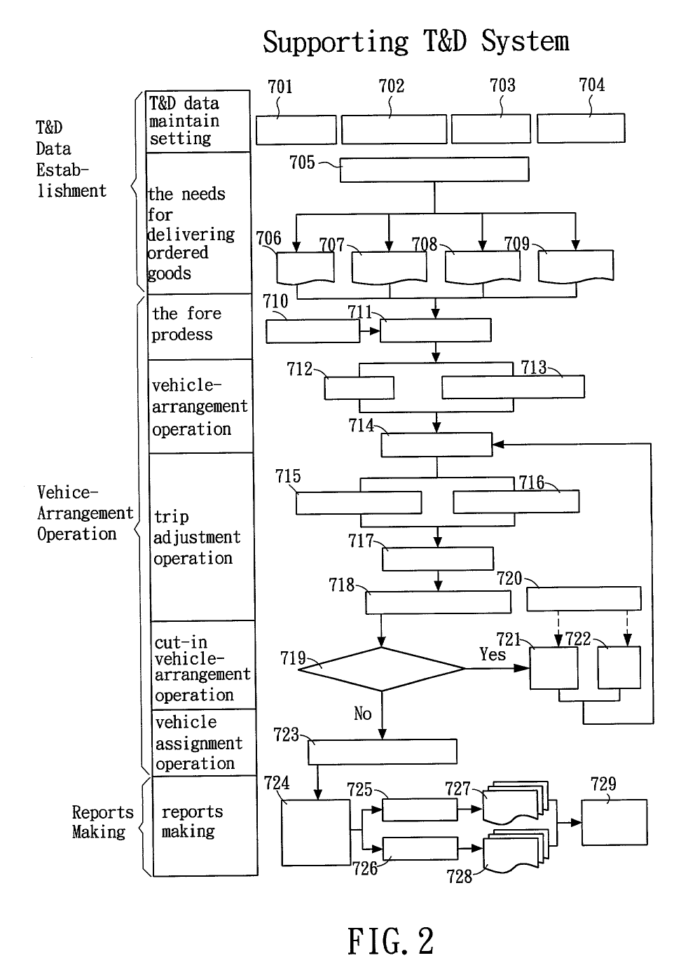

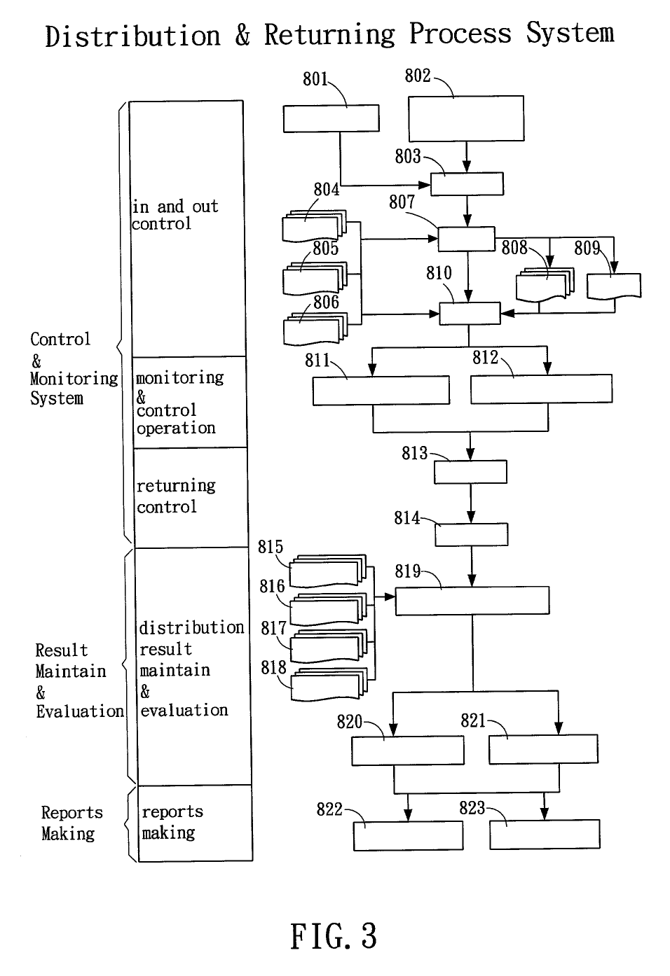

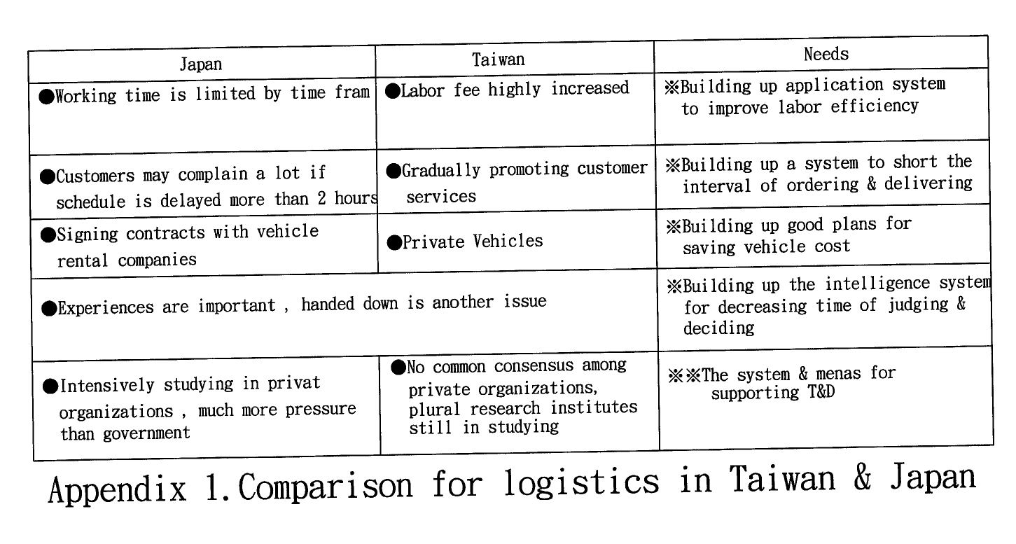

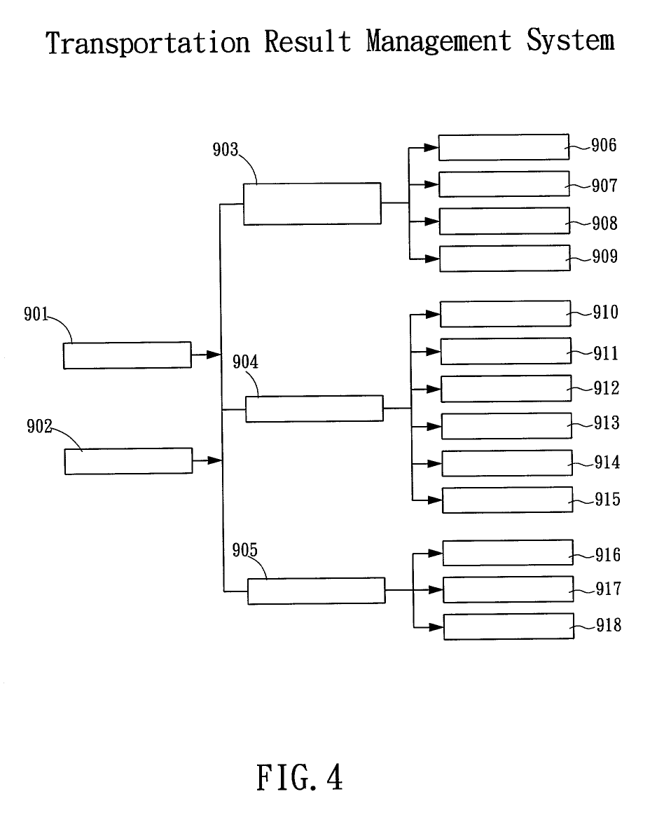

For procedure, please refer to FIG. 2, FIG. 3 and FIG. 4. FIG. 2 is the flow chart of the preferred embodiment of the supporting T&D system for the present invention. FIG. 3 is the flow chart of the preferred embodiment of the distribution and returning process system for the present invention. FIG. 4 is the flow chart of the preferred embodiment of the transportation result management system for the present invention.

Please refer FIG. 2, which is the flow chart of the preferred embodiment of the supporting T&D system for the present invention. Entirely, the system is the first operation system of the present invention, another call, upstream operation system. The operation is that to operate a plan under the condition of goods before distribution after an order being accepted. The operation procedures are as following:

(1) T&D Data Establishment:

(a) T&D data maintain setting: which executes the following steps:

step 701: T&D basic data maintain;

step 702: T&D cost setting;

step 703: vehicle-arrangement principle setting;

step 704: customer T&D data maintain;

(b) The needs for delivering ordered goods:

step 705: to process the first coming order, different receipts are then brought out and sorted;

step 706: to process T&D receipts;

step 707: to process transfer receipts;

step 708: to process bills of lading;

step 709: to process goods received receipts and returned purchase receipts; thus, collecting all kinds of receipts and bills from step 706 through to step 709;

(2) Vehicle-Arrangement Operation:

(c) The fore process:

step 710: to deal with routine vehicle-arrangement setting, and to cooperate with the above collected receipts and bills to go to the next step;

step 711: to process vehicle-arrangement fore operation according to the collected receipts and bills, the vehicle-arrangement operation may be executed by two ways;

(d) Vehicle-Arrangement operation:

step 712: to process automatic vehicle-arrangement;

step 713: to process computer added artificial vehicle-arrangement;

the vehicle-arrangement operation may be operated by one of the above two steps, or simultaneously executed by two of them;

step 714: a preliminary result is then come out for preview after finishing vehicle-arrangement;

(e) Trip adjustment operation: there is not only one trip, two steps are then produced, and one of the two steps may be executed according to vehicle-arrangement result:

step 715: to process trip adjustment operation of multiple transfer-trip assemblies;

step 716: to process trip adjustment operation of return-trip assemblies;

step 717: vehicle-arrangement is immediately processed when one of the above assemblies is done;

step 718: when finishing adjustment, to compare the result before trip adjustment (the result of step 714) and the result after adjustment;

(f) Cut-In vehicle-arrangement operation: the following steps are for emergency and deadline situations:

step 719: to check orders; if there is even one new order accepted, the cut-in vehicle-arrangement operation is then executed; the step 720 is started to process the second batch; if there is no order, then going to step 723;

step 720: to process the second batch;

step 721: to process computerize cut-in vehicle-arrangement operation;

step 722: to process artificial cut-in vehicle-arrangement operation; vehicle-arrangement operation may be processed by one or both above operations, thus a result is brought out for preview; then going back to step 714 for restart;

(g) Vehicle assignment operation:

step 723: to process vehicle and driver assignment;

(h) Reports making:

step 724: to print out T&D results, which are an overall plan and a trip list;

step 725: the overall plan is brought out;

step 726: the trip list is come out; the aforesaid two steps are simultaneously executed, the results are produced at the same time as well;

step 727: vehicle-dispatch receipts, etc. are generated after step 725;

step 728: daily reports are made after step 726;

step 729: going to the distribution and returning process system;

Please refer to FIG. 3, which is the flow chart of the preferred embodiment of the distribution and returning process system for the present invention. Entirely, the system is the second operation system of the present invention, another call, midstream operation system. The operation is that to operate the monitoring and control for goods in distribution and goods after distribution when vehicles are on their returning ways under the supporting T&D results are generated. The operation procedures are as following:

(1) Control And Monitoring System:

(a) In-and-out control:

step 801: following the above step 729, which is to deliver the T&D results to the system;

step 802: to move private vehicles or contract vehicles (business organizations purchase their own vehicles or sign contracts with vehicle rental companies) in loading places for distributing goods; step 801 cooperates with step 802, and to continue to the next step;

step 803: after vehicles moving in, the T&D results are then processed for control operation;

step 804: vehicle-dispatch receipts are generated;

step 805: goods-sort receipts are generated;

step 806: goods-distribute receipts are generated;

the aforesaid three steps are processed simultaneously, then cooperating with step 803 to go to the next step;

step 807: to check goods out, and preparing to move out;

step 808: daily reports are come out;

step 809: pass receipts are brought out;

the above two steps are processed at the same time, then cooperating with the steps 804, 805, 806 and 807 to go to the next step;

step 810: vehicles are allowed to pass for moving out;

(b) Monitoring and control operation:

There are two situations for vehicles in motion after vehicle moving out, which are as the following:

step S11: to monitor and control vehicles in motion via GPS/GIS and wireless communication technology;

step 812: to use HT (Handy Terminal) and wireless communication technology collecting delivery conditions and to report them back to delivery center;

(c) Returning control:

step 813: to finish delivery;

step 814: to process control operation within and after vehicle returning; the returning place may be the original place where vehicles come from, or at least one other place where has goods to be delivered;

(2) Result Maintain and Evaluation:

(d) Distribution result maintain and evaluation:

step 815: generating fuel receipts;

step 816: generating receipts of against traffic regulations;

step 817: generating toll way tickets and receipts;

step 818: generating maintain receipts;

the above four kinds of results are possibly generated at the same time, on the other hand, just one or plurality of them; other items may be probably brought out, thus the steps may not be four, perhaps the step number is more or less than four; the four results of the above steps cooperate with step 814 to go to next step;

step 819: to generate daily vehicle-assignment recording and maintain; then, there are two steps may follow, which are:

step 820: to valuate contract vehicles;

step 821: to valuate drivers' rewards;

(3) Reports Making:

(e) Reports making:

step 822: according to the results of steps 820 and 821, an evaluation report is then come out;

step 823: to move into the transportation result management system according to the results of steps 820 and 821;

Please refer to FIG. 4, which is the flow chart of the preferred embodiment of the transportation result management system for the present invention. Entirely, the system is the third operation system of the present invention, another call, downstream operation system. The operation is that to regularly and irregularly analyze the supporting T&D results of goods before distribution and the evaluation results of monitoring and control of goods in distribution and goods after distribution when vehicles are on their returning ways. The operation procedures are as following:

step 901: to transfer the supporting T&D results from the supporting T&D system to the transportation result management system; simultaneously, the next step is processed;

step 902: to transfer the evaluation results from the distribution and returning process system to the transportation result management system;

step 903: to manage cost, expense, benefit and reward;

step 904: to manage drivers and vehicles;

step 905: to manage resources and energy;

the above three steps are processed together, and the following steps are generated by them:

step 906: to succeed step 903 and to manage consign expenses.

step 907: to succeed step 903 and to manage drivers' rewards.

step 908: to succeed step 903 and to manage cost.

step 909: to succeed step 903 and to manage benefit.

step 910: to succeed step 904 and to manage drivers' duties.

step 911: to succeed step 904 and to manage vehicles' assignments.

step 912: to succeed step 904 and to manage records against traffic regulation.

step 913: to succeed step 904 and to manage refueling.

step 914: to succeed step 904 and to manage maintain records.

step 915: to succeed step 904 and to manage toll way tickets and receipts.

step 916: to succeed step 905 and to manage time.

step 917: to succeed step 905 and to manage stowage.

step 918: to succeed step 905 and to manage mileage and velocity.

As a conclusion of the aforesaid, the present invention clearly divides the logistic procedure into three sections, which are goods before distribution, goods in distribution and goods after distribution, and then to combine means with plural modules to fully disclose the present invention.

As mentioned above, the present invention has been described in connection with specific exemplary embodiments, it should be appreciated that modifications or changes may be made to the embodiments of the present invention without departing from the inventive concepts contained herein.

What claimed is:

1. A system for supporting transportations and distributions (T&D), which is applied on the management of supporting T&D of delivering goods from a place to at least one other place, the system consists of plural systems:
a supporting T&D system, which processes a plan operation for goods before distribution after accepting orders, procedures of the operation are as following:
(1) T&D data establishment;
(2) Vehicle-arrangement operation;
after the above procedures, at least a supporting T&D result is then generated;
a distribution and returning process system, which processes a monitoring and control operation for goods in distribution and goods after distribution when vehicles are on their returning ways under the supporting T&D result is generated, procedures of the operation are as following:
(1) Control and monitoring operation;
(2) Result maintain and evaluation;
after the above procedures, at least an evaluation result is then come out;
a transportation result management system, which processes that to regularly and irregularly analyze the supporting T&D result of goods before distribution and the evaluation result of monitoring and control of goods in distribution and goods after distribution when vehicles are on their returning ways, plural analyzed items are as following:
(1) Cost/expense/benefit/reward management;
(2) Drivers/vehicles management;
(3) Resources/energy management.

2. The system for supporting T&D as cited in claim 1, wherein, the T&D data establishment of the plan operation for goods before distribution of the supporting T&D system includes following:
(a) T&D basic data maintain setting;
(b) The needs for delivering ordered goods.

3. The system for supporting T&D as cited in claim 1, wherein, the vehicle-arrangement operation of the plan operation for goods before distribution of the supporting T&D system includes following:
(a) The fore process;
(b) Vehicle-arrangement operation;
(c) Trip adjustment operation;
(d) Cut-in vehicle-arrangement operation;
(e) Vehicle assignment operation.

4. The system for supporting T&D as cited in claim 1, wherein, the control and monitoring operation of goods in distribution and goods after distribution when vehicles are on their returning ways of the distribution and returning process system includes following:
(a) In-and-out control;
(b) Monitoring and control operation;
(c) Returning control.

5. The system for supporting T&D as cited in claim 1, wherein, the result maintain and evaluation of the distribution and returning process system depends on receipts of vehicles in distribution and daily vehicle-assignment records to maintain and valuate, thus contract vehicle valuation results, driver reward valuation results, etc. are then generated.

6. The system for supporting T&D as cited in claim 3, wherein, the fore process of item (a) is a routine and fore vehicle-arrangement operation.

7. The system for supporting T&D as cited in claim 3, wherein, the vehicle-arrangement of item (b) depends on one of the following types to process: automatic vehicle-arrangement, computer added artificial vehicle-arrangement; a preliminary result for preview is then brought out.

8. The system for supporting T&D as cited in claim 3, wherein, the trip adjustment operation of item (c) focuses on one of the following trip assemblies to process: multiple transfer-trip assemblies, return-trip assemblies; and comparison and confirmation are executed before and after adjustment.

9. The system for supporting T&D as cited in claim 3, wherein, the cut-in vehicle-arrangement operation of item (d) recognizes that there is even one new order accepted or not after the comparison and confirmation of item (c) are done; if not, to continue next item; if yes, to process the second batch of orders, and taking one of the following vehicle-arrangements: computerize cut-in vehicle-arrangement, artificial cut-in vehicle-arrangement; a preliminary result for preview is then brought out, and going back to item (c) for re-arrangement.

10. The system for supporting T&D as cited in claim 4, wherein, the in-and-out control of item (a) focuses on the following vehicles: private vehicles (business organizations purchase their own vehicles), contract vehicles (sign contracts with vehicle rental companies), etc.

11. The system for supporting T&D as cited in claim 4, wherein, the monitoring and control operation of item (b) consists of: vehicles in motion, collecting delivery conditions and report them back to delivery center, etc.

12. The system for supporting T&D as cited in claim 4, wherein, the returning control of item (c) is the control operation within and after vehicle returning.

13. The system for supporting T&D as cited in claim 12, wherein, vehicles may return to a place, and the place is one of the following: original place where vehicles come from, at least one other place where has goods to be delivered.

14. A means for supporting T&D, which is applied on the management of supporting T&D of delivering goods from a place to at least one other place, the means consists of plural modules:
an geographic information system application module, which may calculate the shortest distances for goods loading places to customers' places, customers' places to customers' places, etc. according to data of customers and distributions;
an vehicle-arrangement and path plan module, which may arrange distributions' sequences depending on data in database via automatic, artificial or cut-in vehicle-arrangement process, thus an order path network simulation is then brought out; the path network simulation is sent to the geographic information system application module for displaying distribution paths; a vehicle and driver assignment module may recommend distribution paths and cooperate data of transportation companies, characteristics of each vehicle and driver, cost, etc. to process vehicle and driver assignment and goods distribution for each trip;
a monitoring and recording module, which may function the control and monitor of goods in distribution, which means to control each vehicle running conditions when goods in distribution, and to monitor and record vehicle paths and distribution time interval to the time of distribution finished, which means to monitor and record all situations until vehicles arriving at loading places.

15. The means for supporting T&D as cited in claim 14, wherein, the data of customers and distributions in the geographic information system application module is collected and sorted by a basic data module, and the data include following: T&D data maintain, vehicle-arrangement principle, region data maintain, customer T&D data check and maintain, etc.

16. The means for supporting T&D as cited in claim 15, wherein, the data in T&D data maintain include following: private vehicles (business organizations purchase their own vehicles), contract vehicles (sign contracts with vehicle rental companies), etc.

17. The means for supporting T&D as cited in claim 14, wherein, the procedure of the path network simulation are following:
(a) To find order data from the data of region data maintain and customer T&D data check and maintain, and to generate results after establishment;
(b) The results cooperates with the geographic information system application module to develop further logistic network result, etc.;
(c) Vehicle-arrangements and path plans are brought out.

18. The means for supporting T&D as cited in claim 14, wherein, the procedure of the vehicle and driver assignment are following:
(a) To find relative data from the data of T&D data maintain and vehicle-arrangement principle, and to process the vehicle and driver assignment;
(b) To print out assignment result checks;
(c) An overall plan is then produced.

19. The means for supporting T&D as cited in claim 14, wherein, the loading places may be one of the following: original place where vehicles come from, at least one other place where has goods to be delivered.

20. The system for supporting T&D as cited in claim 3, wherein, the vehicle assignment operation of item (e) processes the assignment for vehicles and drivers.
